(19) United States
(12) Patent Application Publication
(10) Pub. No.: US 2009/0037280 A1
(43) Pub. Date: Feb. 5, 2009

(54) Method of Diagnosing Hair Thinning and Business Method for Promoting Sales of Hair Treatment Products

(76) Inventors: Michael I. Rabin, Gates Mills, OH (US); David A. Smith, Gates Mills, OH (US); Steven Majerus, Gates Mills, OH (US)

Correspondence Address: K. David Crockett, Esq.,;Crockett & Crockett, Suite 200, 26020 Acero, Mission Viejo, CA, 92691, US

(21) Appl. No.: 12/185,045

(22) Filed: Aug. 1, 2008

Related U.S. Application Data
(60) Provisional application No. 60/963,024, filed on Aug. 1, 2007.

(51) Int. Cl. G06Q 50/00; G06Q 30/00

(52) U.S. Cl. 705/14

(57) ABSTRACT

A method of business uses a hair and or scalp scanner such as a hair densitometer to raise awareness of the prevalence of hair thinning. Incentives provided to hair care providers for using the hair scanner increases the likelihood that clients of the hair care provider will be exposed the hair scanner. Sales of hair regrowth products may also be discounted for clients of hair care providers.

### RELATED APPLICATIONS

This application claims priority from co-pending U.S. Provisional Patent application 60/963,024 filed Aug. 1, 2007.

### FIELD OF THE INVENTIONS

The inventions described below relate to the field of human hair growth and thinning and specifically to techniques for quantifying aspects of human hair related to pattern thinning.

### BACKGROUND OF THE INVENTIONS

Hair loss is a widespread problem in males (up to 50% affected) and a significant problem in post-menopausal women. Generally, awareness that one has a problem with hair loss occurs very late in the hair loss-process, after a significant percentage of thinning and loss has occurred. This is due in part to denial on the part of aging men and women, but also in part to the lack of readily available mechanisms to objectively determine hair loss. Not only is hair re-growth treatment more effective at an early stage, but increasing awareness of progressive hair loss increases the market opportunity for hair re-growth and scalp treatment therapies.

### SUMMARY

A hair densitometer or other hair and or scalp scanning device may be used to non-invasively and objectively measure multiple hair characteristics and quantify the degree of hair thinning a person is experiencing. As with most medical issues early detection of hair thinning is an important factor in successfully addressing the problem.

A hair scan device such as a hair densitometer collects data from a consumer's hair and or scalp and transmits image and or other data along with a unique user ID or key and a unique scanner identifier, to a central server. Data transmission may be accomplished using any suitable technique such as cellular telephone, WiFi, internet, etc. The data is processed centrally and result(s) are returned to the hair scan device or otherwise to the consumer. A coupon or other printed report is printed with a unique key; part of the unique key may be a portion that identifies the hair scan device which in turn is linked to a hair care provider. The printed coupon may also include the scan result(s) plus other relevant information for the consumer, hair care provider, etc. The consumer may use the printed coupon to purchase hair regrowth products at brick and mortar stores or online and may redeem the coupon online where the consumer then registers to receive discounts online or in the mail, views image results, gets educated, participates in online surveys for further discounts, sets up a recurring products delivery schedule by providing a credit card, Pay Pal account, etc. The referring hair care provider receives an incentive such as a commission or reward and may receive recurring incentives each time the referred consumer reorders. Individuals may also receive a referral incentive or reward and may receive a recurring incentive for referring consumers who then make purchases. Hair re-growth products may include hair re-growth preparations such as minoxidil, devices for applying hair re-growth preparations, and other devices such as light therapy devices.

A business method for generating revenue derived from the sale of hair restoration products includes the steps of introducing a user to a hair scanner having a unique identification code, scanning a first test area of the user's head with the hair scanner to generate first test data and a unique user identifier, saving the first test data related to the unique user identifier, scanning a reference area of the user's head with the hair scanner to generate reference test data, saving the reference test data related to the unique user identifier, comparing the first test data with the reference test data to generate a hair loss ratio, providing the user with written report of the hair loss ratio, the report including a unique user identifier and the identification code of the hair scanner, providing financial incentive to the user to purchase hair restoration products, the incentive related to the unique user identifier, and providing financial incentive to the hair care operator based on hair restoration product purchases related to the hair care operator's hair scanner unique identification code. The method is accomplished through the participation of hair care providers, which may be barbers, stylists, dermatologists or the like.

Early-to-mid stage hair loss is almost entirely manifested as thinning of the hair shafts of a large percentage of follicles and retarded shaft growth so that the hairs that are present are thin, light and close to the scalp, while follicle density and shafts per follicle are basically unchanged. Only at end-stage baldness do the follicles become irreversibly inactive. The hair densitometer may be used to measure and compare hair characteristics of one or more areas of hair from the top and or front of a human head against the same hair characteristics from one or more areas of hair from the left and or right sideburn area of a human head.

Hair thickness or density D may be quantified as the product of three factors: (1) follicular density, F, measured in follicles per square centimeter, (2) average number of hair shafts per follicle, N, and (3) average thickness, T, of the hair shafts. The product of these three quantities that indicates hair density D.

D=F*N*T

Another possible objective measure of hair thinning may be the fraction of hair widths outside two standard deviations for a selected subset of hair from the head.

In another alternative measure of hair density, hair thickness (diameter) may be replaced with hair cross sectional area A=πT²/4. The overall sense or indicator of “fullness” of a head of hair may also include the hair length L, resulting in a hair volume parameter V=F*N*A*L. Since one can increase the sense of hair volume by letting remaining hair grow, V serves as an appearance metric but masks hair thinning. Thus, D=FNA will be the objective standard used.

Typical follicular unit densities are in the range of 60-120 cm⁻² and each follicle generally contains one or two shafts, but rarely, more than two hair shafts of varying ages. Hair shaft thickness may be classified as coarse, medium or fine and the mean value of the shaft thickness will vary from about 40 microns in width for fine hair, while coarse hair might average 90 microns in width. N will generally be a number between 1 and 2, and more commonly 1-1.25 it can be eliminated from the density determination but may need to be considered in some rare cases.

A normalized hair density measurement for every individual is the ratio of top and or front hair density to left and or right side hair density. Thus, an individual's hair thinning ratio may be expressed as:

R=100×(Dₜₒₚ)/D_{side}

With Dₜₒₚ and D_{side}=F*N*T for each respective region.

A hair densitometer may employ optical and or electronic techniques combined with mechanical manipulation to obtain an objective measure of hair thinning on a human head. The mechanical system nondestructively engages, separates and aligns hair to be analyzed. Then a scanning magnification system illuminates a linear detector array to automatically measure, record and analyze hair widths. One measure of thinning is the ratio R determined between a test area and a reference area. Another measure of hair density relates to the fraction of hairs that are more than a certain number N of standard deviations below the mean measured thickness will be defined as one potential hair loss and or thinning factor. Yet another assessment of hair thinning may be determined from the change in dielectric constant of an aggregation of hair shafts in a test and a control area of a scalp.

### BRIEF DESCRIPTION OF THE DRAWINGS

FIG. 1 is a graph of a hair width spectrum.

FIG. 2 is a graph of hair width spectrums taken from different areas of a human head.

FIG. 3 is a diagram of a hair sample technique taken along a part line.

FIG. 4 is a comparison diagram of actual hair shafts at two locations in a target region relative to the detector output.

FIG. 5 is an exploded view of a scanning system for a hair densitometer.

FIG. 6 is a set of comparison views of hair scans from different areas of a human head and a calibration scale.

FIG. 7 is photograph of a hair densitometer applied to a head.

FIG. 8 is several perspectives of a hair densitometer.

FIG. 9 is a table of hair density analysis for different areas of a head.

FIG. 10 is a block diagram of an optical detector for a hair densitometer.

FIG. 11 is a diagram of a detector output signal related to a hair sample viewed by the optical detector.

FIG. 12 is a perspective view of a capacitive comb for hair density analysis.

FIG. 13 is a perspective view of a technique for capacitive analysis of hair density.

FIG. 14 is a block diagram of a method of doing business using a hair densitometer.

### DETAILED DESCRIPTION OF THE INVENTIONS

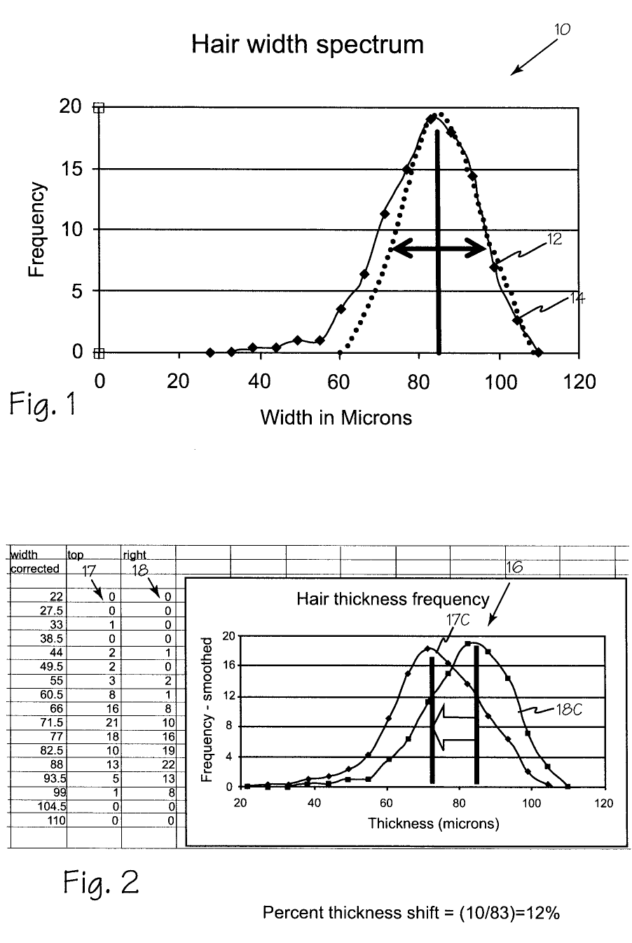

In FIG. 1, graph 10 represents hair thickness measurements for a sample of 100 hairs taken from the top of the head of a 58-year old with a receding hairline. Thickness measurements were obtained by aligning hairs on a millimeter scale and capturing a digital microscope image under various magnifications against a 1 mm registration scale. The width of each hair shaft was measured to 0.5 mm accuracy on ten blown-up images which were scaled according to the 1 mm registration lines. Data points such as data point 12 were smoothed by replacing the data count with the average of the data count for data point 12 and the data count for its nearest neighbors such as data point 14.

Graph 16 of FIG. 2 illustrates the difference between hair samples from the top of a head, data 17 and curve 17C, with samples from the side of the same head, data 18 and curve 18C.

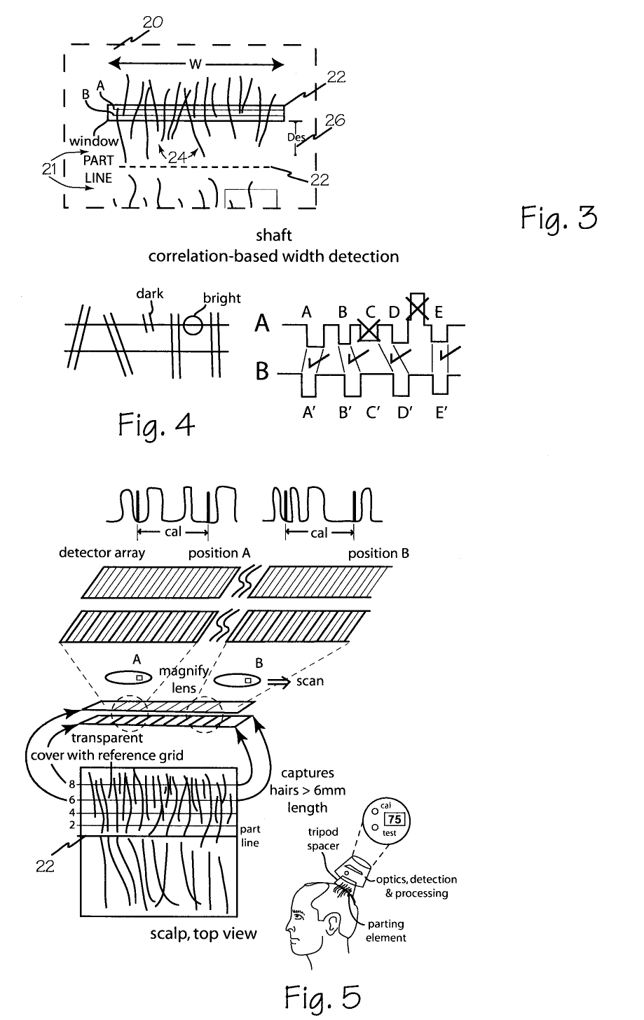

A hair densitometer technique illustrated in FIGS. 3, 4 and 5 includes identifying two different target regions such as target region 20 on a subject's head. For example, target regions might include top and right side, front and right side, top and left side or front and left side. Hair 21 in each target region is parted along a part line 22 forming a test region 23. A hair densitometer measures the count and thickness of hairs 24 at a calibrated distance 26 above the part line in the test region.

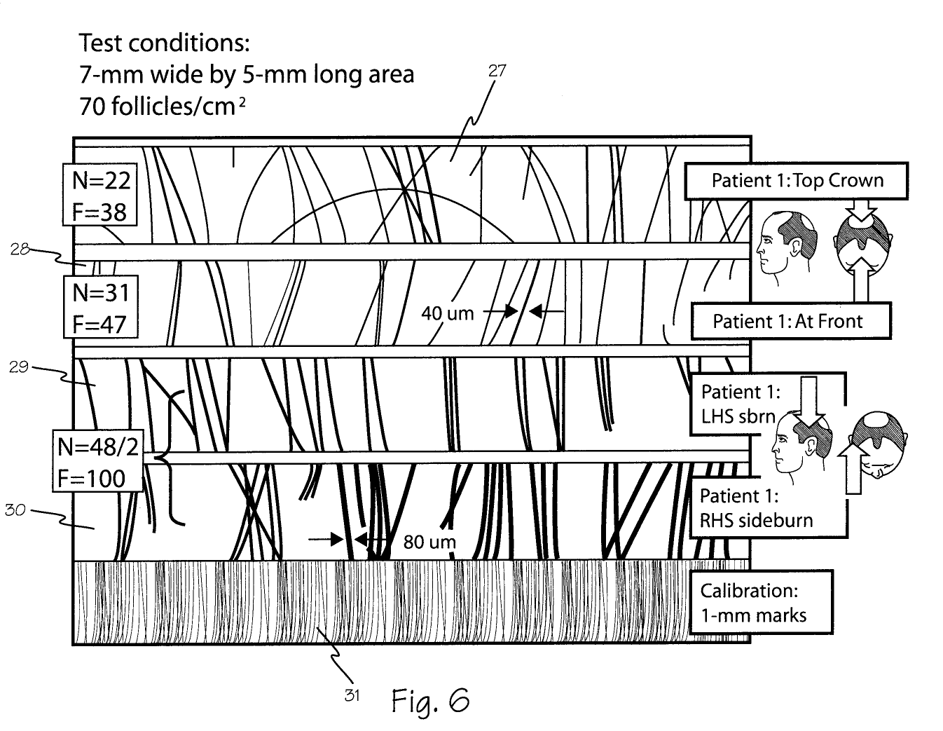

Referring now to FIG. 6, test regions 27, 28, 29 and 30 illustrate varying hair characteristics as a function of location on a head. Calibration scale 31 is available to enable accurate determination of hair shaft diameter.

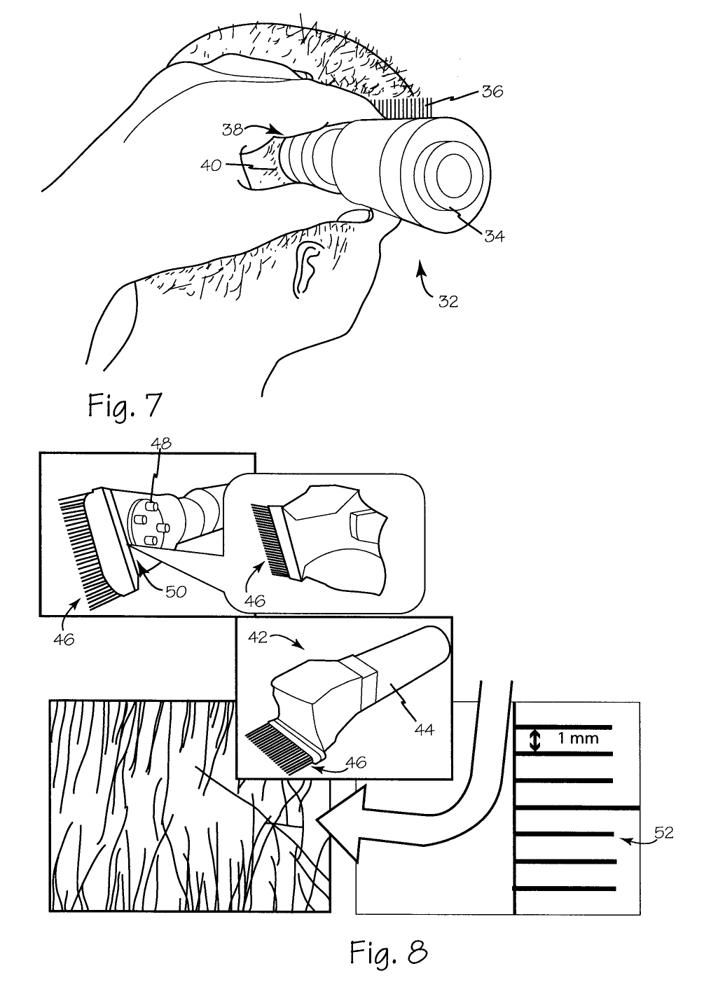

Hair Densitometer 32 of FIG. 7 includes a magnifying imaging apparatus 34 and any suitable mechanical apparatus to align hair for imaging such as comb attachment 36 and any suitable illumination source. Hair analysis images are obtained through a window such as window 38 that includes a calibration scale such as mm scale 40.

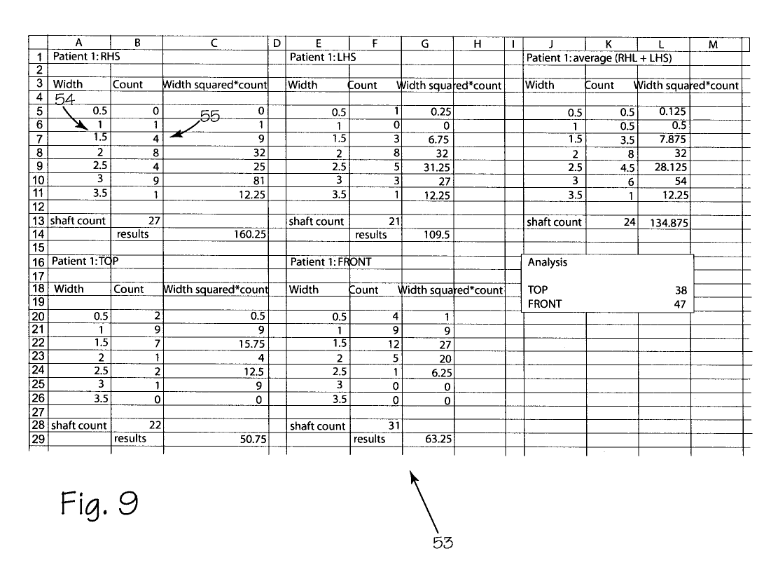

Alternate hair densitometer 42 of FIG. 8 includes a magnifying imaging apparatus 44 and any suitable mechanical apparatus to align hair for imaging such as comb attachment 46 and any suitable illumination source such as LEDs 48. Hair analysis images are obtained through a window such as window 50 that includes a calibration scale such as mm scale 52. Hair visible through window 50 may be counted and measured by a technician or by any suitable automated system. When the hair is counted and measured by a human, data table 53 as illustrated in FIG. 9 may be created to compile data such as measurement data 54 and count data 55.

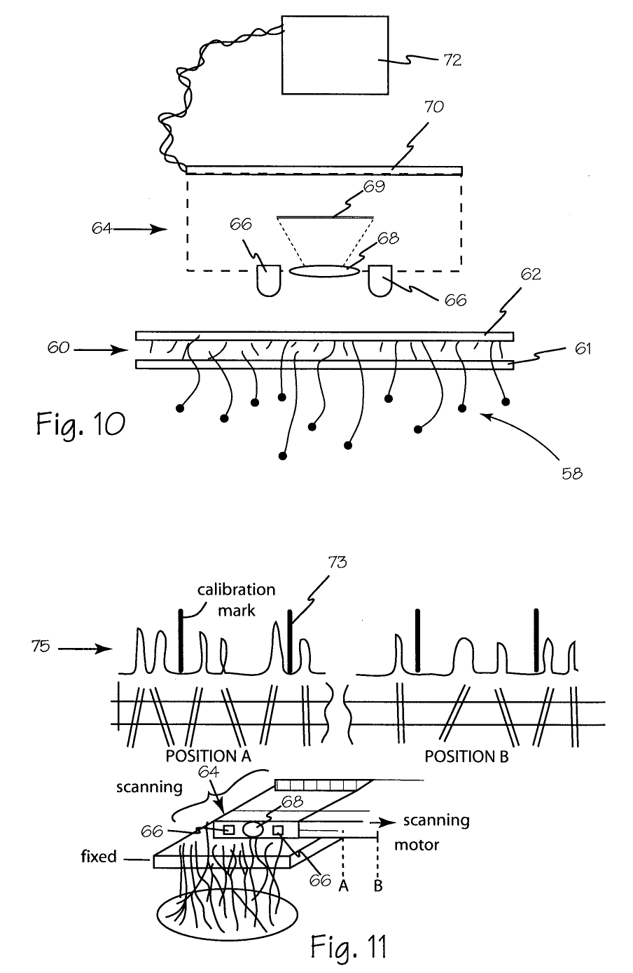

Automated hair densitometer 56 of FIG. 10 engages hair 58 from a test area of a subject's head into collector area 60 where hair 58 is pressed between a suitably colored background 61, here white, and clear plate 62. Scanning assembly 64 includes LEDs 66 and magnifying lens 68 which magnifies the view of collector area 60 and projects image 69 onto detector 70. Scanning assembly may also include incremental scanning of collector area 60 into for example, 2-4 mm portions as shown in FIG. 11. Upon completion of scan data capture, the data may be processed by processor 72 as discussed above. Calibration scale 71 may be identified in detector signal 74.

The performance of a hair densitometer as described may be altered by the use of alternative illumination techniques such as polarized light, multiple wavelength light sources, infrared or UV sources. Imaging and or processing improvements for grey, blonde and or other light colored hair types may also be employed such as for example, washable dyes or coatings, scalp coloring or other suitable techniques.

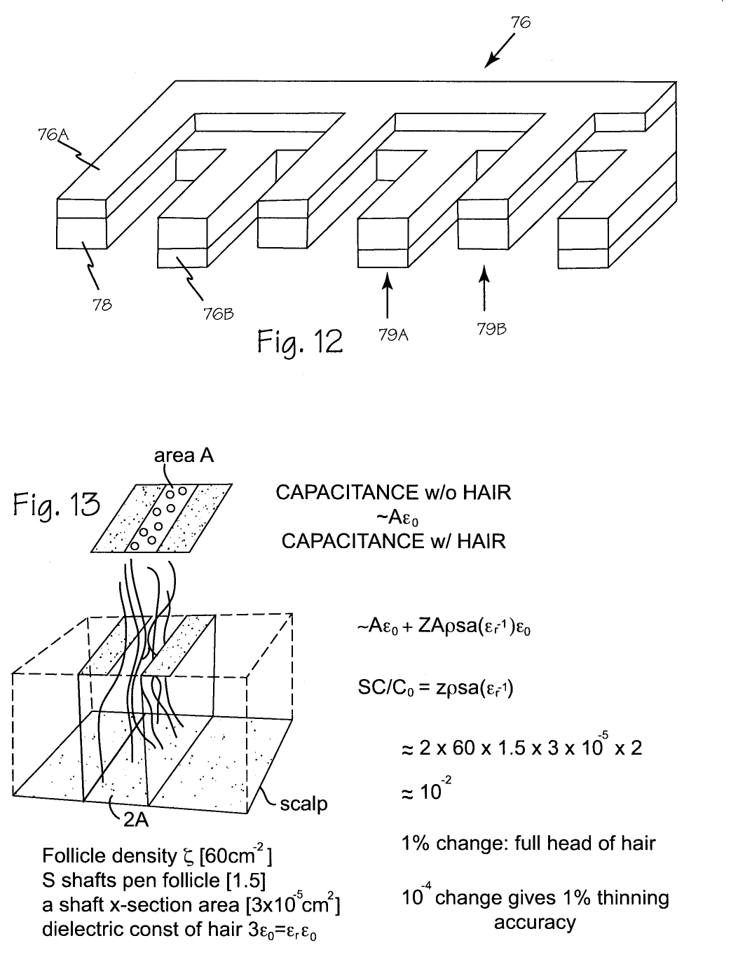

Referring now to FIG. 12 and FIG. 13, an alternate hair densitometer may adapt capacitive techniques to replace imaging in other configurations. Capacitive comb 76 includes capacitive plates 76A and 76B separated by insulating layer 78. Any hair shafts engaged between comb fingers such as fingers 79A and 79B will alter the capacitance and thus may be detectable and quantifiable. Because human hair has a different dielectric constant than air, the insertion of just a single hair in the comb finger capacitor will cause a noticeable change in capacitance. This change can be integrated over a long period of time, thereby constituting a huge over-sampling ratio. This integration period will be chosen to be long enough to negate the effects of phase-noise on non-ideal resonant networks. Essentially, this method allows for cheap but accurate transduction of low-frequency signals. Any observed capacitance shifts will occur due to hair density variations.

By placing the comb-capacitor in a resonant network such as a free-running oscillator a non-imaging detector may be formed. In this topology, any capacitance changes in the comb structure will correspond to linear changes in the oscillation frequency of the circuit. A microcontroller can count the number of cycles per second to obtain a rough readout of the capacitance value. Thus if two measurements are performed and the number of cycles per second are significantly different, then the hair densities are quite different.

For instance, suppose that the free-running frequency of the oscillator in air is 100 kHz. As soon as any non-conductive material (such as hair) passes between the comb fingers, the capacitance of the structure will increase. This increase in capacitance will reduce the 100 kHz free-running frequency.

Insertion of the comb into a relatively dense section of hair (side-of-head) will reduce this frequency of oscillation by as much as a one to a few percent. Integrated over a long sample-time of one second, this corresponds to a change of a few thousand digitally detectable cycles. When the comb is applied to a less-dense area of the scalp (for instance the top), the oscillation frequency will approach the free-running frequency. A simple measure of hair density is therefore proportional to the difference in the two measured frequencies. In short, the magnitude of the difference in oscillation frequencies will correspond to the magnitude in the difference in hair densities.

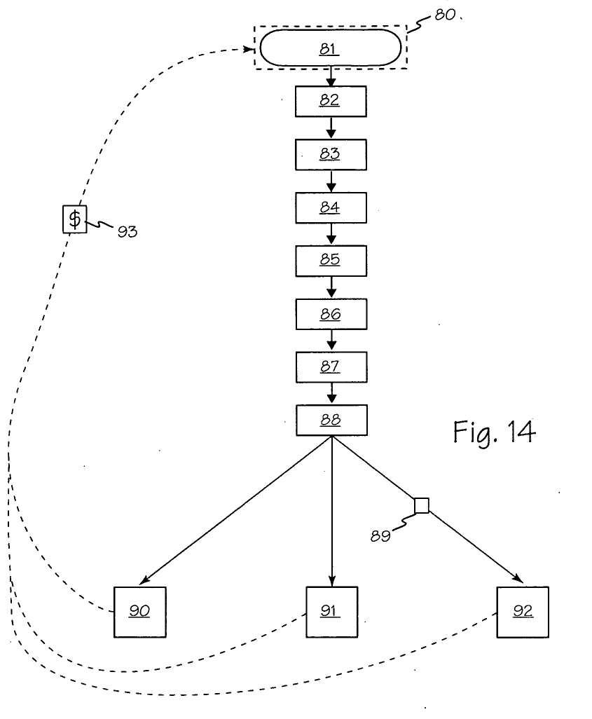

Use of a hair scanner such as a hair densitometer may generate interest in hair restoration techniques and products which will generate revenue which may be used to incentivise referral sources. For example, a hair care provider (a barber, hair stylist or dermatologist (block 80 in FIG. 14) may recommend at step 81 a patron or other user to submit to a hair density analysis. At step 82, the hair care provider 80 selects a test area in an area of potential hair thinning such as the top, front or back of the user's head and performs a first scan. At step 83 the data from the first scan is captured. At step 84, hair care provider 80 selects a reference test area in an area of low potential hair thinning such as the left or right side of the user's head and performs a second scan. At step 85 the data from the second scan is captured. At step 86 the first and second scan data are analyzed and compared to generate a thinning ratio. At step 87 the hair scanner or other connected equipment such as a display or printer may present the results of the hair analysis along with one or more unique identifiers such as keys to uniquely identify the user and the hair scanner. At step 88 the user may use the hair analysis results and one or more cost incentives such as coupon 89 to purchase hair restoration products and or services. The purchase of hair restoration products and or services from a conventional retail outlet such as retailer 90, from an online source such as network retailer 91, or from a service provider such as hair care provider 80 and or salon 92, may generate an incentive such as incentive 93 to the referral source such as hair care provider 80. This method improves the awareness of the prevalence of hair thinning and the effectiveness of early intervention. Incentives to referral sources and product and service providers will further expand the market and increase revenues.

The business method in which hair density measurements are made by a hair care provider and transmitted to business entity that can offer coupons to patients, and thereafter track purchases by the patient through the coupon use and associate purchases with the beautician or dermatologist and compensate the hair care provider with a commission based on those purchases may be accomplished with any hair density measurement system.

The method may be accomplished with data transmitted to a business entity which is competent to analyze hair densitometer readings and comparisons, or analyze scalp photographs or any other data or information indicative of hair loss, whereupon the business entity provides reports to the patient and the hair care provider taking the measurements, along with a coupon (a physical coupon or e-coupon or promotion ID number) bearing indicia uniquely associating the coupon with the hair care provider, and tracking use of the coupon and providing compensation to the hair care provider if and when the coupon is used by the patient. The coupon should offer some incentive, such as a discount on consumables (minoxidil or the like, or devices for applying minoxidil) or other consumer reward. To accomplish this method, a hair care provider may use a camera, cell phone or camera that interfaces with a cell phone or any other suitable wired or wireless apparatus to capture an image of target to be scanned on a client such as the top of a client's head (as illustrated in FIG. 6), or may use the densitometer described above to obtain data regarding the condition of the patient's hair. The hair care provider will then transmit the densitometer readings or an image including the hair care provider's identification and client's information (e.g., telephone number, e-mail address, unique codes, initials, etc.) via any suitable protocol to a data server operated by the business entity offering services under the business method. The business entity, through operation of the data server will respond to hair care provider and “client” by providing coupons, e-coupons or promotion ID numbers and instructions for redemption (through mail, e-mail, text message or any other means). The business entity may also make image and other information such as a manual or automated image analysis for thinning hair available to the “client” via the internet for the purpose of education, marketing, sales, etc. (for example, to encourage the patient to monitor the condition of his or her hair on a regular basis to encourage sale of hair re-growth preparations and devices) and may also make image & “client” related information such as subsequent purchase information available to the initiating hair care provider for the purpose of paying the hair care provider commissions on images, associated sales, etc. and/or enabling the hair care provider to better manage clients.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A business method comprising the steps of:
introducing a user to a hair scanner having a unique identification code;
scanning a first test area of the user's head with the hair scanner to generate first test data and a unique user identifier;
saving the first test data;
scanning a reference area of the user's head with the hair scanner to generate reference test data;
saving the reference test data;
comparing the first test data with the reference test data to generate a hair loss ratio;
providing the user with written report of the hair loss ratio, the report including the unique user identifier and the identification code of the hair scanner;
providing financial incentive to the user to purchase hair restoration products, the incentive related to the unique user identifier; and
providing financial incentive to the hair care operator based on hair restoration product purchases related to the hair care operator's hair scanner unique identification code.

2. A business method comprising the steps of:
transmitting to a business entity which is competent to analyze data or information indicative of hair loss of a patient;
providing a report to the patient, along with a coupon bearing indicia uniquely associating the coupon with the hair care provider;
tracking use of the coupon by the patient;
providing compensation to the hair care provider if and when the coupon is used by the patient;
wherein the coupon is redeemable by the patient for a discount on consumable hair re-growth products.
